(19) United States
(12) Patent Application Publication
(10) Pub. No.: US 2017/0191757 A1
(43) Pub. Date: Jul. 6, 2017

(54) OXYGEN BOOSTING AND NATURAL GAS REPLACEMENT OF COKE IN CUPOLAS

(71) Applicants: Reed Heine, Annandale, NJ (US); Andrew Richardson, Clinton, NJ (US); Thomas Niehoff, Munich (DE)

(72) Inventors: Reed Heine, Annandale, NJ (US); Andrew Richardson, Clinton, NJ (US); Thomas Niehoff, Munich (DE)

(21) Appl. No.: 15/370,441

(22) Filed: Dec. 6, 2016

Related U.S. Application Data
(60) Provisional application No. 62/263,870, filed on Dec. 7, 2015.

(51) Int. Cl. F27B 1/16; C21B 11/02

(52) U.S. Cl. CPC F27B 1/16; C21B 11/02

(57) ABSTRACT

A cupola furnace includes at least one tuyere opening into an interior of the cupola; and at least one oxygen stream and at least one natural gas (NG) stream in fluid communication with said at least one tuyere for providing oxygen and NG to the cupola furnace interior. A related method is also provided for heating a cupola furnace, and includes introducing at least one oxygen stream and at least one NG stream into the cupola furnace for reaction therein.

### BACKGROUND

The present embodiments relate to oxygen boosting in cupola furnaces.

In known cupola furnaces, preheated air is blown through nozzles or tuyeres into an open raceway region at a bottom of a shaft furnace filled with coke and iron ore. The pre-heated air reacts with the carbon to form a hot reducing gas that heats and reduces the iron ore to crude molten iron than flows down and pools at a bottom of the furnace shaft. A cupola furnace is used to produce iron from steel scrap or pig iron. Such furnaces also produce mineral wool.

Referring for example to FIGS. 1-3, a cupola of a furnace is shown generally at A and includes an internal combustion chamber B in which a raceway region C is provided. The raceway region C is that area of the combustion chamber B wherein air is introduced as referenced by arrow D. The air may be cold blast air of approximately 25° C. or hot blast air at approximately 450°-600° C. A melting zone within the combustion chamber B can be approximately 1,300°-1,700° C. The air is introduced into the raceway region C of the combustion chamber D through at least one and for many applications a plurality of injection assemblies. Each injection assembly E includes a pipe F and at leat one tuyere G. The preheated air D introduced through the tuyere G into the raceway region C contacts coal and iron ore at a bottom of the cupola A to form a hot reducing gas that heats and reduces iron ore to molten iron which flows downward and pools at a bottom of the cupola, whereupon it is removed through an outlet H of the furnace as shown by the arrow. The molten iron exiting the outlet H can be at a temperature of from approximately 1,480°-1,530° C. The heated carbon monoxide (CO) rich flue gas from the combustion is removed from the cupola A through an exhaust I as shown by the arrow. The CO rich flue gas can be directed to a post-combustion chamber (not shown).

It is also known to enrich the combustion in the cupola A by introducing oxygen as shown in FIGS. 2-3. As shown in FIG. 2, oxygen may be introduced through a pipe J into the pipe F to mix with the air D. The mixture of the air and oxygen in the pipe F is introduced into the tuyere G for introduction into the raceway region C of the cupola A. In FIG. 3, the oxygen stream is introduced directly into the tuyere G where it mixes with the air D from the pipe F, before the mixture is introduced from the tuyere into the raceway region C.

While the utilization of oxygen enrichment and oxy-fuel burners is known in this industry to increase capacity and reduce coke consumption, the use of oxy-fuel burners can cause extremely high local temperatures and local temperature non-uniformities and consequently, an uneven reaction with the coke bed and undesirable doming or collapse of the bed into the raceway C.

### SUMMARY OF THE INVENTION

There is therefore provided herein an cupola furnace for producing iron or mineral wool, comprising at least one tuyere, and at least one oxygen lance and at least one natural gas lance in operative communication with an interior of said at least one tuyere.

There is also provided herein a method for combustion within cupola furnaces for producing iron or mineral wool, comprising introducing at least one oxygen stream and at least one natural gas stream into a cupola of said furnace.

There is also provided herein a method for combustion within iron cupola furnaces, comprising introducing at least one oxygen stream and at least one natural gas stream into at least one tuyere of a cupola of said furnace.

### BRIEF DESCRIPTION OF THE DRAWINGS

For a more complete understanding of the present invention, reference may be had to the following description of exemplary embodiments considered in connection with the accompanying drawing Figures, of which:

FIGS. 1-3 show a known furnace copola and related components;

FIG. 4 shows a side view partially in cross-section of a lance or tuyere apparatus of the present inventive embodiments;

FIG. 5 shows a side view partially in cross-section of another lance or tuyere apparatus of the present inventive embodiments; and

FIGS. 6A and 6B show schematics on separate drawing sheets of the piping and instrumentation diagram/drawing (“P&ID”) for a mechanical flow train of the present embodiments.

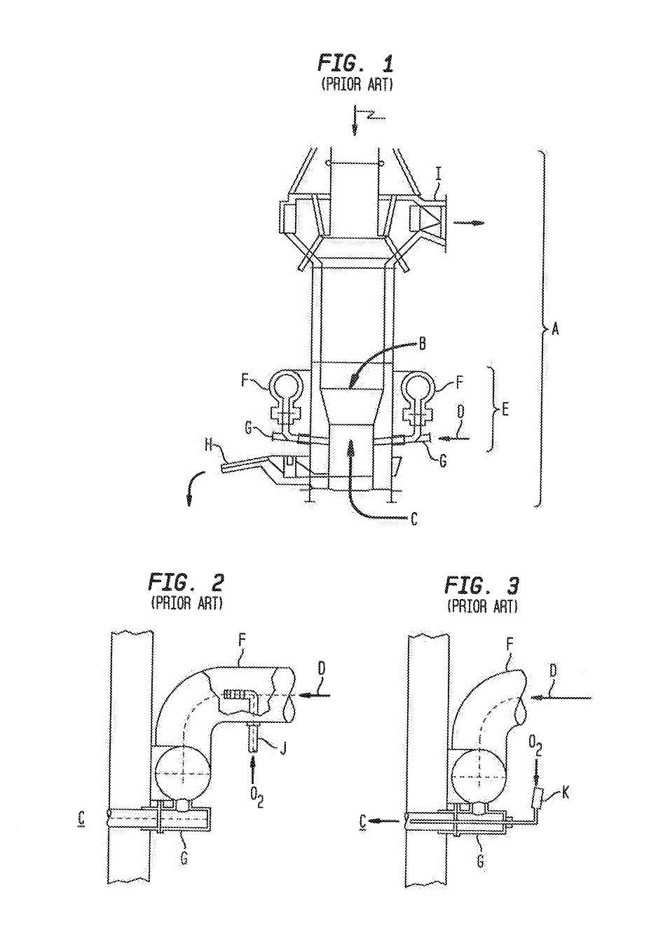

### DETAILED DESCRIPTION OF THE INVENTION

Before explaining the inventive embodiments in detail, it is to be understood that the invention is not limited in its application to the details of construction and arrangement of parts illustrated in the accompanying drawings, if any, since the invention is capable of other embodiments and being practiced or carried out in various ways. Also, it is to be understood that the phraseology or terminology employed herein is for the purpose of description and not of limitation.

In the following description, terms such as a horizontal, upright, vertical, above, below, beneath and the like, are to be used solely for the purpose of clarity illustrating the invention and should not be taken as words of limitation. The drawings are for the purpose of illustrating the invention and are not intended to be to scale.

The present embodiments provide for the introduction of separate, high velocity oxygen and natural gas (NG) jets into the raceway region C, thereby creating a reaction zone distributed between the oxygen and natural gas for reducing peak flame temperatures, and creating a more even, uniform temperature within the raceway and thus obviating disadvantages resulting from high oxy-fuel flame temperatures.

The present embodiments introduce at least one oxygen stream and at least one natural gas stream into at least one tuyere or nozzle of an iron furnace cupola or a mineral wool furnace cupola.

By using oxygen and natural gas in the cupola, the production by the cupola is enhanced and the utilization of coke reduced per ton of iron produced.

A cupola may have a plurality of tuyeres. However, with the present embodiments, not all of the tuyeres need to be fitted with the oxygen and natural gas lances, as the high velocity oxygen lances will serve to homogenize the atmosphere in the raceway region C below the bed through a stirring action created by the lances. For example, in one embodiment described below and used with a cupola consisting of eight (8) tuyeres, only four (4) of the tuyeres will have oxygen and natural gas lances fitted thereto.

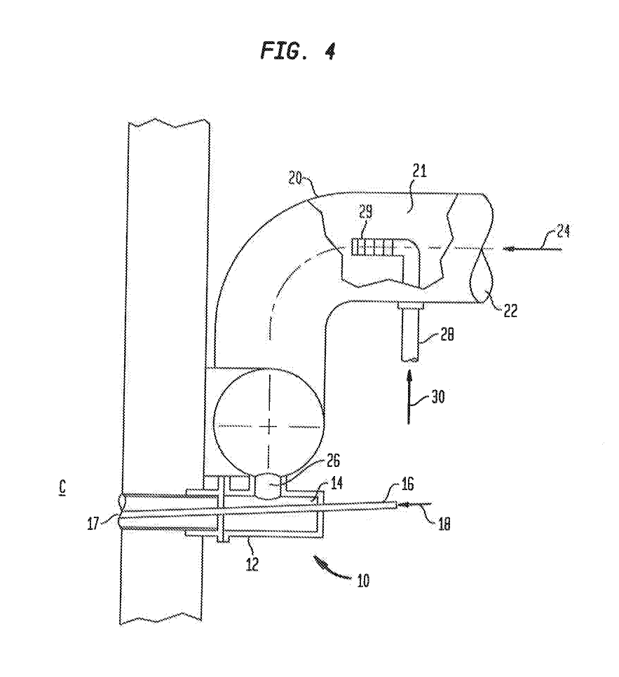

Referring to FIG. 4, an injection assembly apparatus of the present embodiment is shown generally at 10. The apparatus includes at least one tuyere 12 having an internal space 14 therein which is sized and shaped to receive a lance 16 for delivering natural gas (NG) 18 through the tuyere and into the raceway region C of the cupola A. A pipe 20 is constructed with an inlet 22 to receive blower air 24 into the pipe, and an outlet 26 in fluid communication with the space 14 of the tuyere 12. A lance 28 extends into the pipe 20 to introduce an oxygen stream 30 into the blower air 24 at the interior 21 of the pipe 20.

The lance 16 may have a distal end 17 opening into the raceway region C such that blower air 24 and the oxygen stream 30 comingle and mix with the natural gas stream 18 in the raceway region C. An alternate embodiment calls for the distal end 17 terminating at a position within the space 14 of the tuyere 12 such that the blower air 24, the oxygen stream 30 and the natural gas stream 18 comingle and mix within the tuyere before the mixture is introduced into the raceway region C. For example, the lance 16 may open into the space 14 at a position approximately four inches (4″) from where the raceway region C is exposed to the tuyere 12.

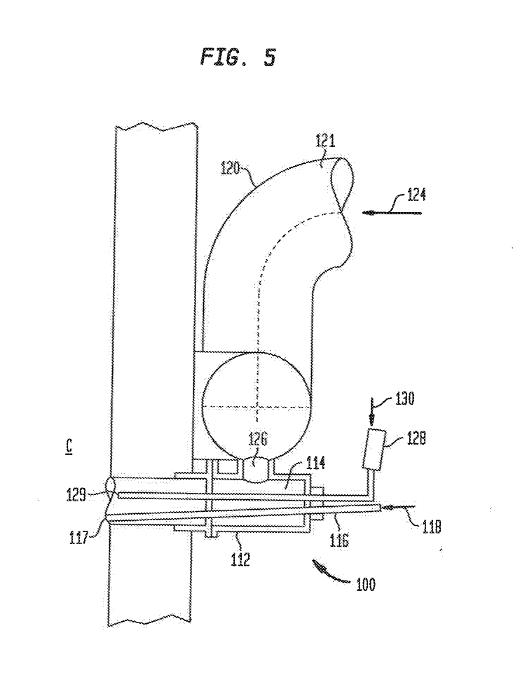

Another exemplarary embodiment of an injection assembly apparatus in accordance with the present invention is illustrated in FIG. 5. Elements illustrated in FIG. 5 which correspond to the elements described above with respect to FIG. 4 have been designated by corresponding reference numerals increased by one hundred. The embodiment of FIG. 5 is designed for use in the same manner of the embodiment in FIG. 4, unless otherwise stated.

Referring to the embodiment in FIG. 5, an injection assembly apparatus is shown generally at 100 and includes at least one tuyere 112 having an internal space 114 sized and shaped to receive both the natural gas lance 116 to provide the natural gas stream 118, and an oxygen lance 128 to provide the oxygen stream 130. As shown in this embodiment in FIG. 5, the space 114 can accommodate the natural gas lance 116 and the oxygen lance 128 in a side-by-side arrangement. As with the apparatus embodiment of FIG. 4, a distal end 117 of the natural gas lance 116 can open into the raceway region C or alternatively, open at that point within the space 114 further away from the raceway region. For example, the lance 116 can open into the space 114 at a position approximately four inches (4″) from where the raceway region C is exposed to the tuyere 112. A similar arrangement of the oxygen lance 128 can also be provided. That is, a distal end 129 of the oxygen lance 128 can open into the raceway region C, or an alternate embodiment can open within the space 114 at a point approximately four inches (4″) by way of example only, from where the raceway region C is exposed to the tuyere 112. In effect, the distal ends 117, 129 can be positioned similarly or at alternate positions within the space 114 and with respect to the raceway region C. The injection assembly apparatus 100 of FIG. 5 can therefore have the distal ends 117, 129 positioned with respect to each other and the blower air 124 being introduced through the pipe 120 to determine the extent to which the blower air 124, the natural gas stream 118 and the oxygen stream 130 will be mixed and where such mixture will occur with respect to the raceway region C.

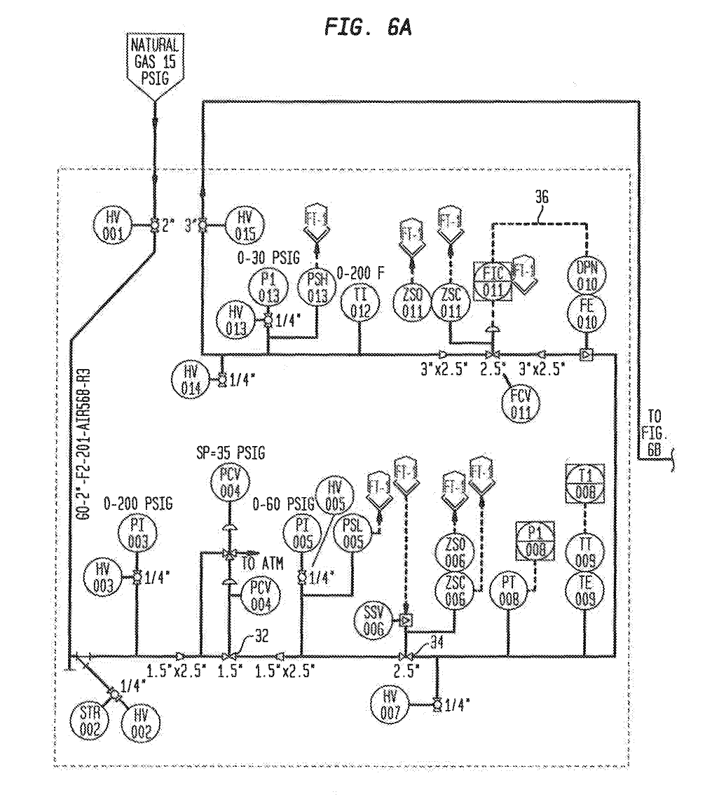

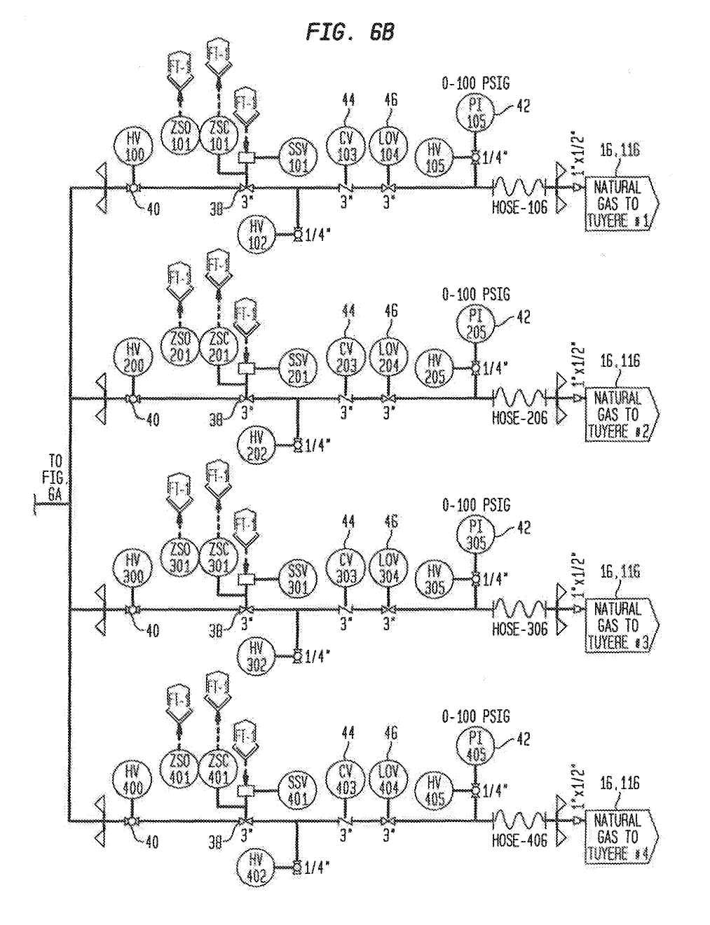

FIGS. 6A and 6b show in the P&ID what is occurring upstream of the natural gas lance 16, 116. Referring now to FIGS. 6A and 6B, there is shown a schematic of a mechanical flow train for a cupola with either existing general oxygen enrichment of the air or existing individual tuyere oxygen lances, the present embodiments can be used as a simple natural gas flow control system while maintaining in operation an existing oxygen control system. Use of the independent natural gas flow control system of the present embodiments is therefore a cost effective approach over the supply of new natural gas and oxygen systems for each tuyere G. Such a natural gas flow system for the introduction of natural gas into four tuyeres 12, 112 (out of for example eight tuyeres) is shown in the FIGS. 6A-6B. The present system embodiments include a master pressure regulator 32, shutoff valve 34, flow control section 36 feeding individual lances 16, 116 that are each fitted with an individual shut off valve 38, isolation valve 40, pressure indicator 42, check valve 44 and limiting orifice valve 46 to manually balance the flows. The present system embodiments can be upgraded to individual flow control at each natural gas line feeding a tuyere to provide greater process control, even though perhaps at additional cost.

The oxygen and natural gas lances are separated such that the two streams issuing therefrom do not immediately interact as would occur with a conventional oxy-fuel burner. Rather, with the present embodiments, the mixing is delayed until the two streams are diluted and come together in the raceway region C. As the fluid streams are diluted, and the mixing and consequent reactions between unreacted fuel and oxygen are reduced, the heat released is distributed over a larger region or volume and consequently is more homogenous and with lower peak temperatures than would occur in known systems.

The oxygen and natural gas streams in the present embodiments of FIGS. 4-5, 6A-6B may be provided in sequence or concurrent with each other.

Such a delay in mixing is by the separation between the two jets and the relative velocities of their respective streams 18, 118 and 30, 130. The jet separation can be between directly neighboring lances at a minimum distance from each other, or that which is geometrically possible in view of the inner dimensions of the tuyere 12, 112, thereby providing more room at a greater distance between the lances in the tuyere. However, in practice, the jets may be separated in a range of from for example 2 inches-6 inches to allow for the delay in mixing of the streams 18, 118 and 30, 130.

While both of the streams 18, 118 and 30, 130 can be provided as jets, said jets can have high momentum, and it is practical to use a supersonic (preferably between Mach 1-2) oxygen jet, as the oxygen is often available at high pressure. Such velocities will enable the oxygen jet to be projected into the raceway region C with strong entrainment and subsequent mixing of the surrounding gases present and the natural gas 18, 118.

In certain embodiments there is provided a cupola furnace comprising at least one oxygen lance through which the at least one oxygen stream may pass, and at least one natural gas lance through which the at least one NG stream may pass.

In certain embodiments there is provided a cupola furnace, wherein the at least one NG lance extends through the at least one tuyere to an opening for said cupola interior for delivering the NG thereto.

In certain embodiments there is provided a cupola furnace, wherein the at least one oxygen lance and the at least one NG lance extend through the at least one tuyere to the cupola interior.

In certain embodiments there is provided a cupola furnace, wherein the cupola furnace comprises a plurality of tuyeres, each one of said plurality of tuyeres comprising said at least one oxygen lance and said at least one natural gas lance in fluid communication with one of said plurality of tuyeres.

In certain embodiments there is provided a cupola furnace, wherein the cupola furnace comprises a plurality of tuyeres, and only a portion of said plurality of tuyeres have at least one oxygen lance and at least one natural gas lance.

In certain embodiments there is provided a cupola furnace, wherein the cupola furnace comprises an air inlet for introducing an air stream into said at least one tuyere, and said at least one oxygen lance provides oxygen to said airstream upstream of said at least one tuyere.

In certain embodiments there is provided a cupola furnace, wherein the at least one oxygen lance and the at least one NG lance extend adjacent each other into the at least one tuyere.

In certain embodiments there is provided a method of heating a cupola furnace, comprising introducing at least one oxygen stream and at least one natural gas (NG) stream into said cupola furnace for reaction therein.

In certain embodiments there is provided a method comprising guiding each of the at least one oxygen stream through an oxygen lance, and guiding each of the at least one NG stream through a natural gas lance.

In certain embodiments there is provided a method comprising introducing air to the at least one oxygen stream.

In certain embodiments there is provided a method comprising providing at least one tuyere having an outlet in fluid communication with an interior of said cupola furnace, and an inlet sized and shaped to receive said at least one oxygen stream and said at least one NG stream.

In certain embodiments there is provided a method comprising providing an air stream into said at least are tuyere.

In certain embodiments there is provided a method, wherein the providing the airstream is to said at least one oxygen stream upstream of said at least one NG stream.

In certain embodiments there is provided a method comprising mixing said at least one oxygen stream and said at least one NG stream in said cupola.

In certain embodiments there is provided a method, comprising mixing said at least one oxygen stream and said at least one NG stream in said at least one tuyere.

In certain embodiments there is provided a method comprising introducing the air stream to said at least one oxygen stream for mixing therewith upstream of said at least one tuyere.

In certain embodiments there is provided a method comprising charging the cupola furnace with a material for producing iron.

In certain embodiments there is provided a method comprising charging the cupola furnace with a material for producing mineral wool.

The present embodiments provide natural gas flows in a range of from 50 to 700 scf/ton (standard cubic feet per ton) iron produced. The present embodiments provide pure oxygen flows in a range of from 50-2,800 scf/ton iron produced while injecting natural gas concurrent with oxygen.

The present embodiments provide improved temperature homogeneity in the raceway region C and avoidance of excessive temperatures that could lead to bed instability.

Displacing energy from cupola coke with the natural gas of the present embodiments results in overall reduction of energy costs for making iron or mineral wool.

Using natural gas of the present embodiments at the tuyeres instead of adding coke at the top of furnace provides faster response time to make iron temperature adjustments.

Displacing 3% to 15% coke with natural gas of the present embodiments reduces the volume of coke and hence the total burden volume which thereby results in a potential to increase production of iron or mineral wool from 0.5% to 3%.

It will be understood that the embodiments described herein are merely exemplary, and that a person skilled in the art may make variations and modifications without departing from the spirit and scope of the invention. All such variations and modifications are intended to be included within the scope of the invention as described and claimed herein. It should be understood that the embodiments described above are not only in the alternative, but can be combined.

What is claimed is:

1. A cupola furnace, comprising:
at least one tuyere opening into an interior of the cupola furnace; and
at least one oxygen stream and at least one natural gas (NG) stream in fluid communication with said at least one tuyere for providing oxygen and NG to the interior of the cupola furnace.

2. The cupola furnace of claim 1, further comprising at least one oxygen lance through which the at least one oxygen stream may pass, and at least one natural gas lance through which the at least one NG stream may pass.

3. The cupola furnace of claim 2, wherein the at least one NG lance extends through the at least one tuyere to an opening for said cupola interior for delivering the NG thereto.

4. The cupola furnace of claim 2, wherein the at least one oxygen lance and the at least one NG lance extend through the at least one tuyere to the cupola interior.

5. The cupola furnace of claim 2, wherein the cupola furnace comprises a plurality of tuyeres, each one of said plurality of tuyeres comprising said at least one oxygen lance and said at least one natural gas lance in fluid communication with one of said plurality of tuyeres.

6. The cupola furnace of claim 2, wherein the cupola furnace comprises a plurality of tuyeres, and only a portion of said plurality of tuyeres have at least one oxygen lance and at least one natural gas lance.

7. The cupola furnace of claim 2, wherein the cupola furnace comprises an air inlet for introducing an air stream into said at least one tuyere, and said at least one oxygen lance provides oxygen to said airstream upstream of said at least one tuyere.

8. The cupola furnace of claim 2, wherein the at least one oxygen lance and the at least one NG lance extend adjacent each other into the at least one tuyere.

9. A method of heating a cupola furnace, comprising introducing at least one oxygen stream and at least one natural gas (NG) stream into said cupola furnace for reaction therein.

10. The method of claim 9, further comprising guiding each of the at least one oxygen stream through an oxygen lance, and guiding each of the at least one NG stream through a natural gas lance.

11. The method of claim 9, further comprising introducing air to the at least one oxygen stream.

12. The method of claim 9, further comprising providing at least one tuyere having an outlet in fluid communication with an interior of said cupola furnace, and an inlet sized and shaped to receive said at least one oxygen stream and said at least one NG stream.

13. The method of claim 12, further comprising providing an air stream into said at least are tuyere.

14. The method of claim 13, wherein the providing the airstream is to said at least one oxygen stream upstream of said at least one NG stream.

15. The method of claim 9, further comprising mixing said at least one oxygen stream and said at least one NG stream in said cupola.

16. The method of claim 12, further comprising mixing said at least one oxygen stream and said at least one NG stream in said at least one tuyere.

17. The method of claim 13, further comprising introducing the air stream to said at least one oxygen stream for mixing therewith upstream of said at least one tuyere.

18. The method of claim 9 further comprising charging the cupola furnace with a material for producing iron.

19. The method of claim 9, further comprising charging the cupola furnace with a material for producing mineral wool.
